(19) United States
(12) Patent Application Publication
(10) Pub. No.: US 2025/0180851 A1
(43) Pub. Date: Jun. 5, 2025

(54) SWITCHING MECHANISM, ASSEMBLY MECHANISM AND RABBIT CAGE APPARATUS

(71) Applicant: SHENZHEN NEEWER TECHNOLOGY CO. LTD, Shenzhen (CN)

(72) Inventors: Yuling CHEN, Shenzhen (CN); Jiahui MO, Shenzhen (CN); Jun WANG, Shenzhen (CN); Yan KE, Shenzhen (CN)

(73) Assignee: SHENZHEN NEEWER TECHNOLOGY CO. LTD, Shenzhen (CN)

(21) Appl. No.: 18/414,646

(22) Filed: Jan. 17, 2024

(30) Foreign Application Priority Data
Dec. 1, 2023 (CN) 202323305303.8

(51) Int. Cl. G02B 7/00; G03B 17/56

(52) U.S. Cl. CPC G02B 7/006; G03B 17/566

(57) ABSTRACT

Disclosed are a switching mechanism, an assembly mechanism and a rabbit cage apparatus. The switching mechanism includes: a main body provided with a lens hole for installing a filter, and at least one fixed structure provided on the main body. The fixed structure includes a sliding portion provided with a jointing portion, the sliding portion is configured to slidably mount on the assembly mechanism, and the jointing portion is configured to lock the assembly mechanism.

### CROSS-REFERENCE TO RELATED APPLICATIONS

The present application claims priority to Chinese Patent Application No. 202323305303.8, filed on Dec. 1, 2023, the entire contents of which are incorporated herein by reference.

### TECHNICAL FIELD

The present application relates to the technical field of photographic equipment, and in particular to a switching mechanism, an assembly mechanism and a rabbit cage apparatus.

### BACKGROUND

When taking pictures, different filters are usually replaced and installed on the lens to cover the original lens assembly, so as to obtain special effects photos that filter certain light waves when shooting, which can be applied to mobile phone lenses, camera lenses, etc.

In the related art, taking the mobile phone as an example, in order to install the filter on the mobile phone, a rabbit cage frame and a switching ring are equipped. The mobile phone is installed in the rabbit cage frame, the switching ring is rotated and installed on the rabbit cage, and finally the filter is detachably installed on the switching ring. The filter installed on the rabbit cage frame positioned directly opposite the camera of the mobile phone to cover the camera of the mobile phone.

In U.S. Pat. No. 11,448,847B2, the phone is mounted on the rabbit cage, the switching ring (multi-camera filter mount) is rotatably installed to the rabbit cage frame, and the avoiding hole (orifice) of the switching ring is rotated from the outside of the rabbit cage to the position directly opposite the mobile phone camera provided on the rabbit cage, which is controlled by manual calibration. Especially when the avoiding hole of the switching ring is a square frame, the frame of the square window and the border of the camera in the square area must be aligned during calibration. When the avoiding hole of the switching ring and the camera are skewed or cannot be faced with each other, part of the camera is easily blocked, thus affecting the photo quality.

### SUMMARY

The main purpose of the present application is to provide a switching mechanism, an assembly mechanism and a rabbit cage apparatus, aiming to solve the technical problem.

In order to achieve the above purpose, the present application provides a switching mechanism for assembling with an assembly mechanism, including: a main body and at least one fixed structure;
the main body is provided with a lens hole for installing a filter; and
the at least one fixed structure is provided on the main body, the fixed structure includes a sliding portion configured to be detachably and slidably connected to the assembly mechanism.

In an embodiment, the sliding portion is provided with a bayonet configured to snap with the assembly mechanism.

In an embodiment, the sliding portion includes: a connecting segment and a limiting segment;

one end of the connecting segment is connected to the main body; and
the limiting segment is provided at the other end of the connecting segment, the connecting segment, the limiting segment and main body are enclosed to form the bayonet.

In an embodiment, the bayonet is a breach recessed on the sliding portion, and the breach is spaced apart from the main body.

In an embodiment, the fixed structure is provided with at least one positioning groove configured to cooperate with the assembly mechanism to limit the main body.

In an embodiment, the switching mechanism includes two fixed structures spaced apart on opposite sides of the lens hole.

In an embodiment, each of the fixed structures includes two sliding portions spaced on two sides of the positioning groove.

In an embodiment, each of the fixed structures includes two positioning grooves spaced apart on two sides of the sliding portion.

In an embodiment, the switching mechanism is circular; or the switching mechanism is rectangular.

The present application also provides an assembly mechanism for installing a switching mechanism, including: an installing member;
the installing member is provided with an assembly cavity having an opening, and the assembly cavity is configured for slidably assembling the switching mechanism; and
an extending section is provided on an edge of the assembly cavity, and the extending section is configured to snap into a bayonet of the switching mechanism.

In an embodiment, the assembly cavity includes a pre-positioning cavity and a clamping cavity communicated with the pre-positioning cavity; and
the extending section is provided at a top of the clamping cavity, and the opening is provided at a top of the pre-positioning cavity and is communicated with the pre-positioning cavity.

In an embodiment, the assembly mechanism further includes: a positioning assembly provided in the installing member;
the positioning assembly is spaced apart from the assembly cavity, and is configured to position the switching mechanism.

In an embodiment, the installing member is provided with an accommodating groove spaced apart from the assembly cavity; and
one end of the positioning assembly is elastically installed in the accommodating groove, and the other end of the positioning assembly is configured to elastically limit the switching mechanism.

In an embodiment, the positioning assembly includes:
an elastic member provided in the accommodating groove, wherein one end of the elastic member is connected to a bottom wall of the accommodating groove; and
a positioning member provided at the other end of the elastic member, wherein the elastic member is configured to drive the positioning member to elastically abut against the switching mechanism.

In an embodiment, a compressing or a stretching direction of the elastic member is perpendicular to a plane where the installing member is located.

In an embodiment, an avoiding gap is provided on one edge of the assembly mechanism, and the avoiding gap is configured to abut and limit an assembly sliding of the switching mechanism.

The present application also provides a rabbit cage apparatus, including: a cage frame; the assembly mechanism, and the switching mechanism;
the assembly mechanism is provided in the cage frame; and
the switching mechanism is detachably assembled with the assembly mechanism through the fixed structure.

In an embodiment, the rabbit cage apparatus further includes: at least one soft layer;
the at least one soft layer is provided on the assembly mechanism and/or the switching mechanism; and
in response to that the assembly mechanism is assembled with the switching mechanism, the soft layer is provided between the switching mechanism and the cage frame.

The switching mechanism in the technical solution of the present application includes a main body and at least one fixed structure. The main body is provided with a lens hole for installing a filter. The fixed structure is provided on the main body and is spaced on one side of the lens hole. The fixed structure is configured to detachably install the switching structure on the assembly mechanism. The fixed structure includes a sliding portion, the sliding portion is configured to detachably and slidingly connect the assembly mechanism, so that the switching mechanism can be assembled or disassembled with the assembly mechanism by sliding, which eliminates the need for manual calibration after the rotation, improves the assembly accuracy and assembly stability of the switching mechanism.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1A is a schematic structural view of a switching mechanism according to an embodiment of the present application.

FIG. 1B to FIG. 1G are schematic views of working principle of the switching mechanism of the present application.

FIG. 2 is a schematic view of a back structure of the switching mechanism in FIG. 1A.

FIG. 3 is a schematic structural view of an installation member in the switching mechanism according to an embodiment of the present application.

FIG. 4 is a schematic structural view of a rabbit cage apparatus in use according to an embodiment of the present application.

FIG. 5A and FIG. 5B are schematic exploded structural views of the rabbit cage apparatus according to an embodiment of the present application.

FIG. 6 is a schematic structural view of a pre-assembly operation of the rabbit cage apparatus according to an embodiment of the present application.

FIG. 7 is a schematic cross-sectional structural view along E-E in FIG. 6.

FIG. 8 is a schematic enlarged structural view at Q in FIG. 7.

FIG. 9 is a schematic structural view of the rabbit cage apparatus completely assembled according to an embodiment of the present application.

FIG. 10 is a schematic cross-sectional structural view along F-F in FIG. 9.

FIG. 11 is a schematic enlarged view at M in FIG. 10.

FIG. 12 is a schematic structural view of the rabbit cage apparatus in use according to an embodiment of the present application.

FIG. 13 is a schematic structural view of a switching mechanism in FIG. 12.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that all directional indications (such as up, down, left, right, front, back, etc.) in the embodiments of the present application are only used to explain the relative positional relationship, the movement situation, etc. among various assemblies under a certain posture as shown in the drawings. If the specific posture changes, the directional indication also changes accordingly.

In the description of the embodiments of the present application, unless otherwise explicitly stipulated and limited, the terms “connection” and “connected” should be understood in a broad sense. For example, it can be a fixed connection, a detachable connection or an integrated connection, a mechanical connection or an electrical connection, a direct connection or an indirect connection through an intermediate medium, a connection within two components or an interaction between two components, unless explicitly specified otherwise. For those skilled in the art, the specific meanings of the above terms in the embodiments of the present application can be understood in specific situations.

In addition, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

In the related art, taking the mobile phone as an example, in order to install the filter on the mobile phone, a rabbit cage frame and a switching ring are equipped. The mobile phone is installed in the rabbit cage frame, the switching ring is rotated and installed on the rabbit cage, and finally the filter is detachably installed on the switching ring. The filter installed on the rabbit cage frame is positioned directly opposite the camera of the mobile phone to cover the camera of the mobile phone.

The switching ring rotatably installed cannot be separated from the rabbit cage frame conveniently. The window of the switching ring is rotated from the outside of the rabbit cage to the position directly opposite the mobile phone camera provided on the rabbit cage, which is controlled by manual calibration. Especially when the switching ring is the window with a square frame, the frame of the square window and the border of the camera in the square area must be aligned during calibration. When the frame of the window of the switching ring and the frame of the camera are skewed and cannot be faced with each other, part of the camera is easily blocked, thus affecting the photo quality.

The present application provides a switching mechanism 100, an assembly mechanism 300 cooperated with the switching mechanism 100, and a rabbit cage apparatus 500 provided with the switching mechanism 100 and the assembly mechanism 300. It should be noted that the rabbit cage of the rabbit cage apparatus 500 of the present application can be a mobile phone rabbit cage or a camera rabbit cage. Taking the mobile phone rabbit cage as an example, the mobile phone rabbit cage is configured to mount and fix the mobile phone. The mobile phone rabbit cage component can be configured as a mobile phone holder. The mobile phone holder can also be provided with other accessories. At least one handle can also be provided on a periphery of the mobile phone holder, and the handle can be wooden for easy grabbing and use.

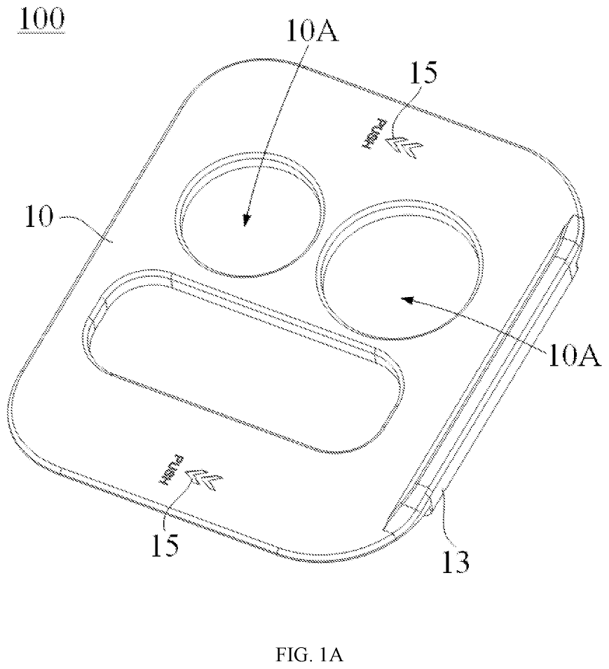

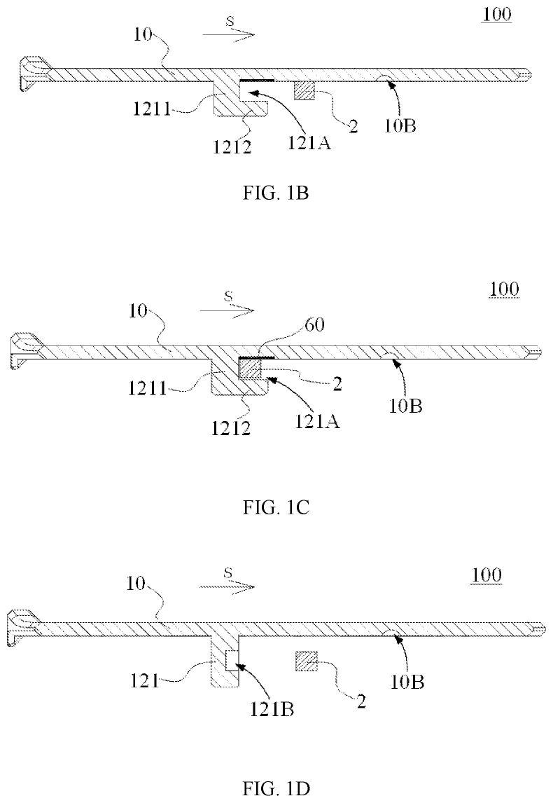

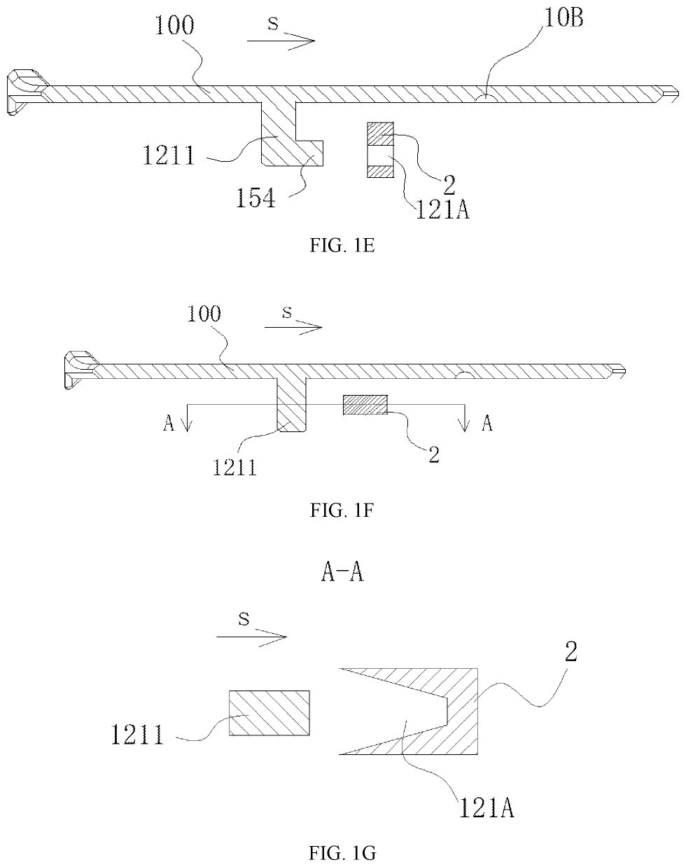

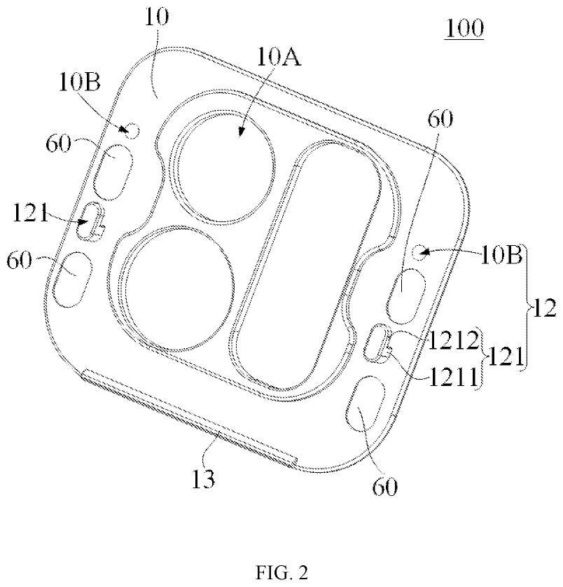

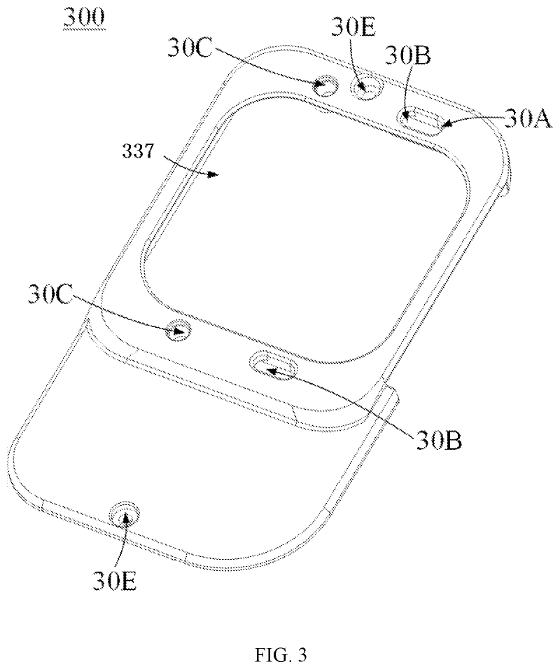

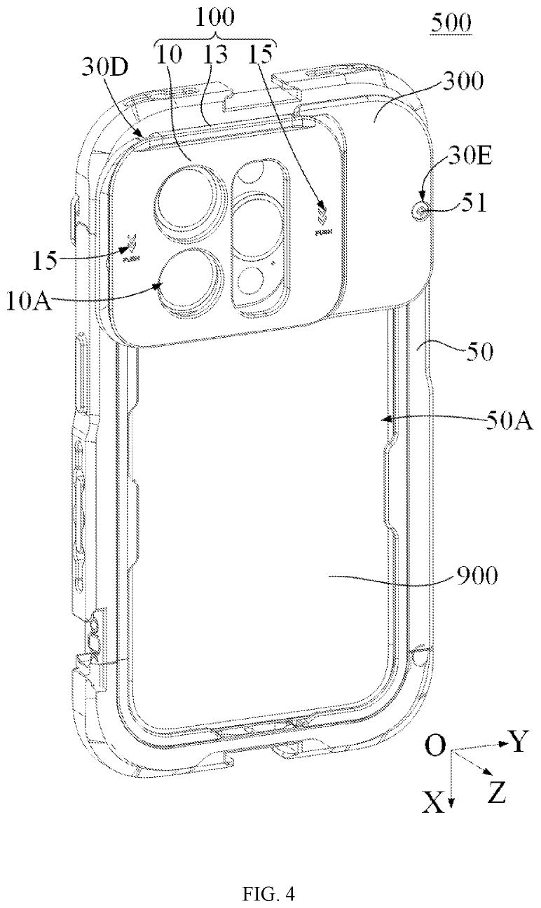

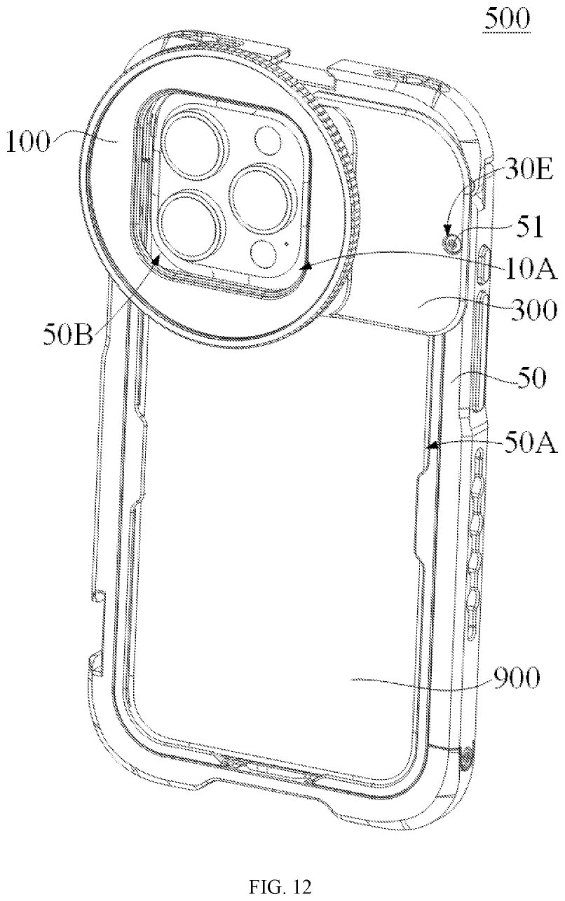

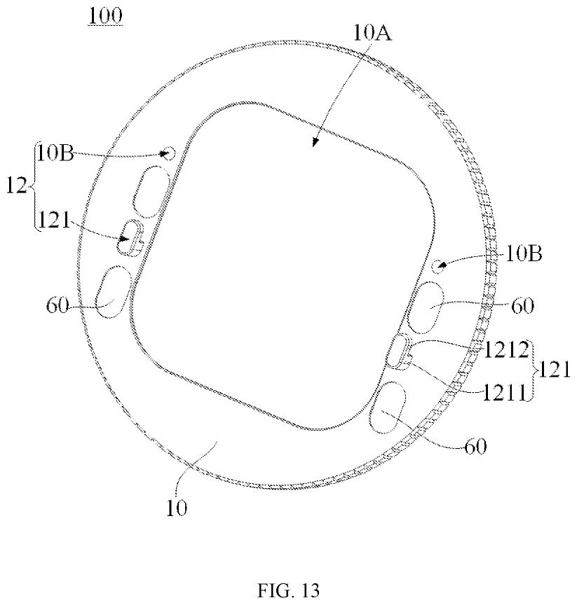

As shown in FIG. 1A to FIG. 13, FIG. 1A and FIG. 2 are schematic structural views of the switching mechanism 100. FIG. 1B to FIG. 1G are schematic views of working principles of the switching mechanism 100. FIG. 3 is a schematic structural view of an installation member 30 of the assembly mechanism 300 of the present application. FIG. 4 to FIG. 11 are schematic structural views of the rabbit cage apparatus 500 before and after assembly. FIG. 12 is a schematic structural view of the rabbit cage apparatus 500 in use according to an embodiment of the present application. FIG. 13 is a schematic structural view of the switching mechanism 100 in FIG. 12.

Please refer to FIG. 1A to FIG. 5B, the switching mechanism 100 is configured to be detachably installed on the assembly mechanism 300, and the assembly mechanism 300 is detachably installed or undetachably fixed on the cage frame 50 to form the rabbit cage apparatus 500.

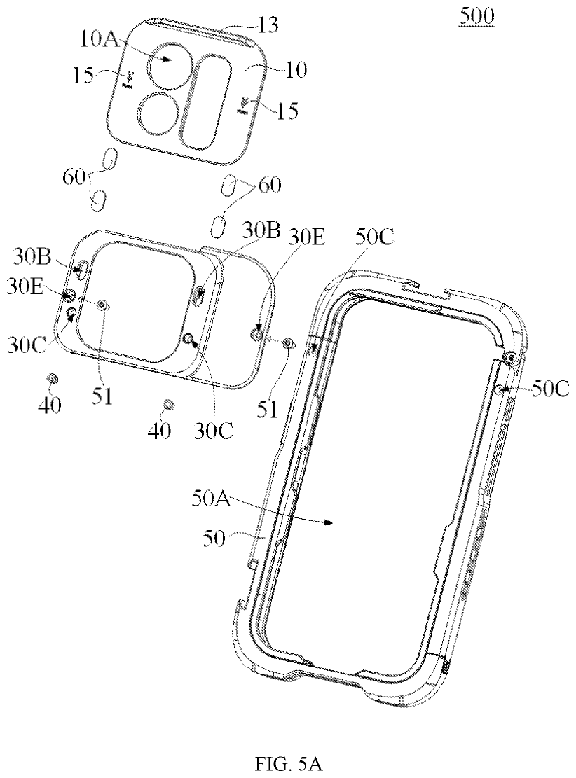

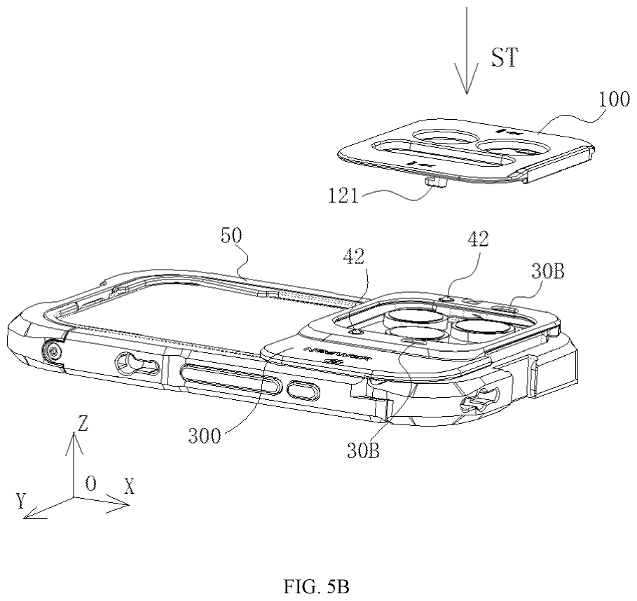

Regarding the rabbit cage apparatus 500, referring to FIG. 4 and FIG. 5A, the rabbit cage apparatus 500 includes a cage frame 50 and an assembly mechanism 300 installed on the cage frame 50. The cage frame 50 is provided with an accommodating chamber 50A for accommodating a shooting terminal 900. The assembly mechanism 300 is provided on the cage frame 50 directly facing the lens module of the shooting terminal 900. The assembly mechanism 300 is provided with a window 337 facing to the lens module after assembled. The switching mechanism 100 is detachably installed on the assembly mechanism 300 to cover the window 337, and different filters are detachably and replaceably installed on the switching mechanism 100 aligned with the window 337, thereby enabling different types of filters to be installed on the rabbit cage apparatus 500 to obtain different mobile phone shooting effects.

In an embodiment of the switching mechanism 100, as shown in FIG. 1A, FIG. 2 and FIG. 4, the switching mechanism 100 is provided with a lens hole 10A corresponding to the lens module, and the lens hole 10A is communicated with the window 337. The switching mechanism 100 includes the main body 10 and at least one fixed structure 12. The main body 10 is provided with the lens hole 10A for installing the filter, and at least one fixed structure 12 is provided on the main body 10. The fixed structure 12 includes a sliding portion 121 with a jointing portion. The sliding portion 121 is configured to be slidably mounted on the assembly mechanism 300, the jointing portion is configured to lock the assembly mechanism 300 after the sliding portion slides on the assembly portion 300. When it needs to mount the switching mechanism 100 to the assembly mechanism 300, operate the switching mechanism 100 slide on the assembly mechanism 300. When the sliding portion 121 encounters a blocking component after the switching mechanism 100 slides to a pre-design position or an extremity limiting position, and the jointing portion is snapped into the blocking component. For example, when the sliding portion 121 slides on the assembly mechanism 300 and encounters a sidewall 2 of the assembly mechanism 300, the jointing portion of the sliding portion 121 is snapped into the sidewall 2, so that the switching mechanism 100 is installed and locked on the assembly mechanism 300, and the lens hole 10A of the switching mechanism 100 is directly facing the lens module of the shooting terminal 900 mounted on the assembly mechanism 300. When it needs to disassembly, the switching mechanism 100 is pushed by a certain force contrary to the S direction to be separated from the sidewall 2.

In an embodiment, the jointing portion of the sliding portion 121 can be a bayonet 121A, and the bayonet 121A is configured for snapping the assembly mechanism 300, When the sliding portion 121 slides on the assembly mechanism 300 and encounters the sidewall 2 of the assembly mechanism 300, the bayonet 121A is snapped into the sidewall 2 of the assembly mechanism 300 and is fixed through a friction between the bayonet 121A and the sidewall 2.

As shown in FIG. 1B, the switching mechanism 100 slides on the assembly mechanism 300 along a S direction, and the bayonet 121A like a “C” shape opening is directly facing the sidewall 2 of the assembly mechanism 300. As shown in FIG. 1C, when the switching mechanism 100 slides to a position where the bayonet 121A encounters the sidewall 2, the bayonet 121A is snapped into the sidewall 2 so that the switching mechanism 100 is connected and locked to the assembly mechanism 300.

In an embodiment, as shown in FIG. 1E, the jointing portion can be an inserting rod 154 fixed on the end of the connecting segment 1211 opposite to the main body 10, and the bayonet 121A is arranged on the sidewall 2 of the assembly mechanism 300. The switching mechanism 100 slides on the assembly mechanism 300 along a S direction, and the inserting rod 154 is directly facing the bayonet 121A. When the switching mechanism 100 slides to a position where the inserting rod 154 encounters the sidewall 2, the inserting rod 154 is inserted into the bayonet 121A of the sidewall 2, so that the switching mechanism 100 is connected and locked to the assembly mechanism 300.

In an embodiment, as shown in FIG. 1F and FIG. 1G, FIG. 1G is a cross-section view along A-A in FIG. 1F. The jointing portion can be just the connecting segment 1211, and the bayonet 121A is arranged on the sidewall 2 of the assembly mechanism 300. The material of the sidewall 2 or the segment 1211 can be elasticity, and the bayonet 121A will clamp the connecting segment 121 when the connecting segment 1211 moves along the direction S and snapped into the bayonet 121A. In this embodiment, the position of the segment 1211 and the bayonet 121A can be reverse: the segment 1211 can be arranged on the sidewall 2 of the assembly mechanism 300, and the bayonet 121A can be arranged on the switching mechanism 300.

Referring to FIG. 1B, the sliding portion 121 includes a connecting segment 1211 and a limiting segment 1212. One end of connecting segment 1211 is connected to the main body 10, and the limiting segment 1212 is provided at the other end of the connecting segment 1211. The limiting segment protrudes and is substantially perpendicular to the connecting segment 1211. The connecting segment 1211, the limiting segment 1212 and the main body 10 are enclosed to form the bayonet 121A. The connecting segment 1211, the limiting segment 1212 and the main body 10 can be integratedly formed, welding formed, thread connection formed, or machining formed. The material of the connecting segment 1211, the limiting segment 1212 and the main body 10 can be metals and hard plastics, such as aluminum, steel, and iron.

The bayonet 121A is positioned directly facing the sidewall 2 of the assembly mechanism 300. The bayonet 121A is formed by enclosing the structure of the sliding portion 121 and the structure of the main body 10. In addition, the bayonet 121A may also be configured as a breach 121B formed on the sliding portion 121.

In an embodiment of the switching mechanism 100, the bayonet 121A is the breach 121B recessed on the sliding portion 121, and the breach 121B is spaced apart from the main body 10.

In an embodiment, as shown in FIG. 1D, the bayonet 121A is the breach 121B recessed on the sliding portion 121, and the breach 121B directly faces the sidewall 2 of the assembly mechanism 300. When the sliding portion 121 slides on the assembly mechanism 300 and encounters the sidewall 2 of the assembly mechanism 300, the breach 121B is snapped into the sidewall 2 of the assembly mechanism 300 to connect the switching mechanism 100 to the assembly mechanism 300.

The more detailed components and working principles involved are described below.

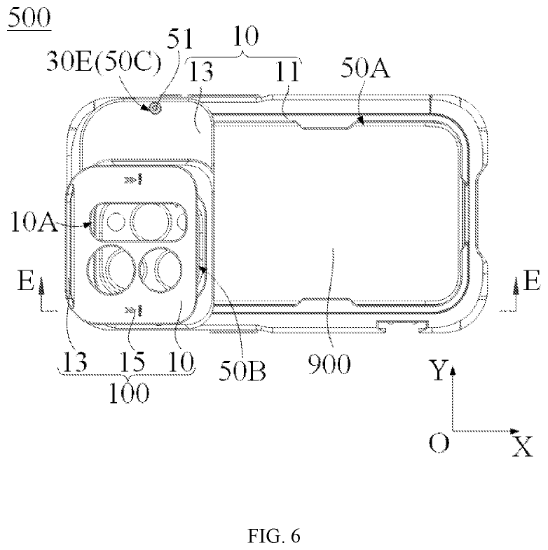

For the assembly mechanism 300, referring to FIG. 3, and FIG. 6 to FIG. 11, the assembly mechanism 300 is provided with an assembly cavity 30B having an opening 30A, and the sliding portion 121 of the switching mechanism 100 is inserted and installed into the assembly cavity 30B, then slides along an X-axis direction as described below, so that the assembly mechanism 300 can be detachably connected to the switching mechanism 100. The assembly cavity 30B plays a role in guiding and positioning. When the switching mechanism 100 slides to the limiting position or the preset position in the assembly cavity 30B and the bayonet 121A is snapped into the sidewall, the switching mechanism 100 covers the window 337 of the assembly mechanism 300, and the lens hole 10A directly faces the camera of the terminal device 900 installed in the rabbit cage assembly 300. The assembly mechanism 300 is detachably connected to the cage frame 50, making it easy to replace the assembly mechanism 300.

In an embodiment, as shown in FIG. 2, at least one fixed structure 12 of the switching mechanism 100 is provided on the main body 10. The fixed structure 12 includes at least one sliding portion 121, and the sliding portion 121 is provided on one side of the lens hole 10A. The sliding portion 121 is detachably and slidingly connected to the assembly mechanism 300. The switching mechanism 100 installs the filter on the rabbit cage apparatus 500 through the assembly mechanism 300, so as to cover the original camera on the shooting terminal 900. The assembly process is easy to operate, which only needs to insert the sliding portion 121 of the switching mechanism 100 into the assembly cavity 30B through the opening 30A of the assembly mechanism 300, and slide the main body 10 relative to the assembly mechanism 300 along the first direction so that the sliding portion 121 is snapped and limited to the inner wall of the assembly cavity 30B and will not be detached without an external force, so as to limit the relative positions of the assembly mechanism 300 and the switching mechanism 100, which eliminates the manual calibration after sliding and improves the stability of the detachable assembly.

It can be understood that, the blocking component is configured as the sidewall 2, and the sidewall 2 in the assembly mechanism 300 can be part of the wall of the assembly cavity 30B, specifically can be an extending section 31 on the assembly mechanism 300. The lens hole 10A, the filter can be threaded, elastically wrapped or magnetically assembled to the lens hole 10A the filter, which is not limited here. That is, the sidewall of the lens hole 10A is provided with threads, and the filter can be threaded with the lens hole 10A through the corresponding threads, or the lens hole 10A is provided with a magnet, and the filter is a material that can be magnetically attracted by the magnet and can be installed in the lens hole 10A through the magnetic attraction.

The sliding direction of the switching mechanism 100 relative to the assembly mechanism 300 is defined as the X axis, the direction of the sliding portion 121 inserting into the assembly cavity 30B is parallel to the Z axis, the direction perpendicular to the Z and X axes is defines the Y axis, the intersection point of X axis, Y axis and Z axis is the origin point O, and the three axes and the origin point O together form a space rectangular coordinate system O-XYZ shown in FIG. 4. The following is based on this coordinate system as the orientation standard, and the embodiments are illustrated with the orientation markings in FIG. 6 to FIG. 11.

With reference to FIG. 6 to FIG. 11, it can be understood that the first direction is parallel to the X-axis direction, the Z-axis direction is parallel to the second direction, and the direction perpendicular to the first direction and the second direction is a third direction, and the third direction is parallel to the Y-axis direction.

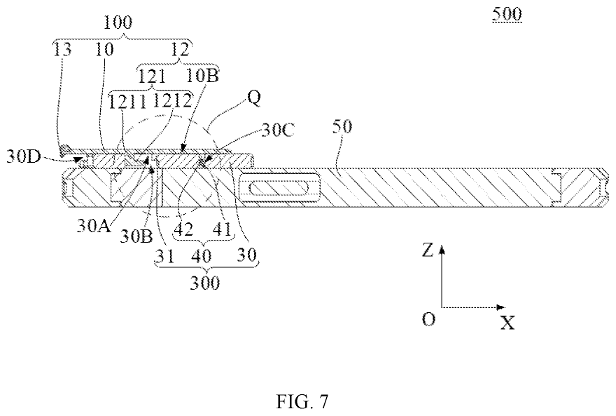

As shown in FIG. 2, FIG. 7 to FIG. 8 and FIG. 10 to FIG. 11, in an embodiment, the fixed structure 12 is provided with at least one positioning groove 10B, and the positioning groove 10B is configured to cooperate with the assembly mechanism 300 to limit the main body 10.

In an embodiment, the assembly mechanism 300 is provided with a positioning assembly 40 corresponding to the positioning groove 10B, the assembly mechanism 300 is provided with an accommodating groove 30C facing the switching mechanism 100 when the switching mechanism is mounted on the assembly mechanism 300, and the positioning assembly 40 is provided in the accommodating groove 30C. After the sliding portion 121 inserted into the assembly cavity 30B from the opening 30A along the Z-axis, as shown in FIG. 5B, the switching mechanism 100 moves along the ST direction to make the sliding portion 121 insert into the assembly cavity 30B from the opening 30A, then the sliding portion 121 is limited along the Y-axis direction and can slide in the assembly cavity 30B along the X-axis. After the sliding portion 121 slides to the preset position or the limiting position along the X-axis, one end of the sliding portion 121 is snapped and limited in the assembly cavity 30B through the jointing portion of the sliding portion 121, so that the sliding portion 121 is limited and locked along the Y-axis and Z-axis directions simultaneously, and the sliding portion 121 will not retreat in the opposite direction along the X-axis without the external certain force. When the sliding portion 121 slides to the preset position or the limiting position, the positioning groove 10B of the switching mechanism 100 is directly facing to the accommodating groove 30C of the assembly mechanism 300. One end of the positioning assembly 40 provided at the accommodating groove 30C elastically extends and pushes into the positioning groove 10B when the switching mechanism 100 slides to the position where the positioning groove 10B is facing the end of the positioning assembly 40, so that the switching mechanism 100 is limited along the X-axis direction, thereby improving the stability of the sliding portion 121 in the assembly cavity 30B and improving the limiting reliability of the switching mechanism 100 relative to the assembly mechanism 300.

It can be understood that, the accommodating groove 30C is opened on the assembly mechanism 300 along the Z-axis direction, and a notch of the accommodating groove 30C is opened towards one side of the switching mechanism 100. When the switching mechanism 100 and the assembly mechanism 300 are not assembled, one end of the positioning assembly 40 is relatively fixedly connected to a bottom wall or a sidewall of the accommodating groove 30C, and the other end of the positioning assembly 40 extends along the Z-axis toward the notch.

In a natural state, one end of the positioning assembly 40 is fixed in the accommodating groove 30C, the other end of the positioning assembly 40 is free, and the free end crosses the notch but cannot leave out.

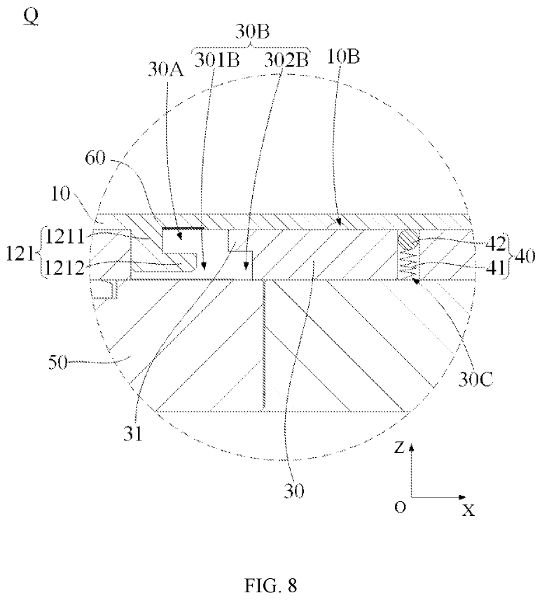

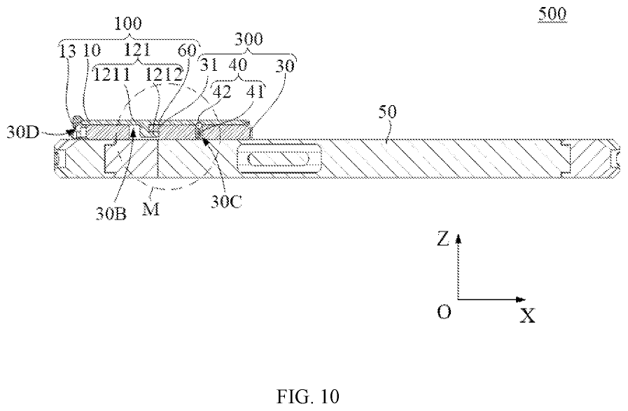

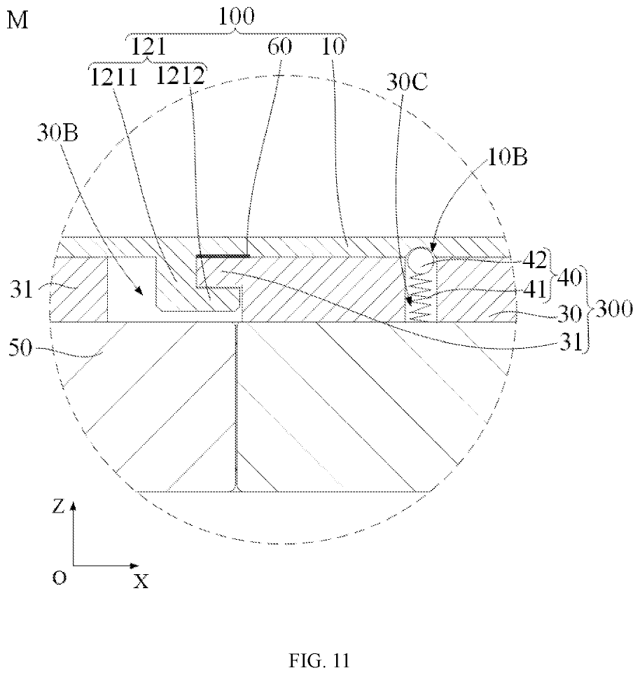

As shown in FIG. 7 and FIG. 8, during the sliding process of the switching mechanism 100 relative to the assembly mechanism 300 along the X axis, the switching mechanism is appressed to an upper surface of the assembly mechanism 300, so that the positioning assembly 40 is pressed down by the switching mechanism 100, the free end of the positioning assembly 40 is pressed down along the Z axis and retracted into the accommodating groove 30C, and the positioning assembly 40 is in a compressed state. As shown in FIG. 10 and FIG. 11, after the sliding portion 121 slides along the X axis to the preset position or the extremity limiting position, the positioning groove 10B directly faces the accommodating groove 30C, so that the free end of the positioning assembly 40 pops out along the Z-axis and is inserted into the positioning groove 10B to limit the sliding direction of the switching mechanism 100 and the assembly mechanism 300 along the X-axis, which improves the assembly stability of the switching mechanism 100 and the assembly mechanism 300.

In an embodiment, the switching mechanism 100 includes two fixed structures 12 spaced apart on opposite sides of the lens hole 10A.

In an embodiment, each of the fixed structures 12 includes the sliding portion 121 and the positioning groove 10B. The sliding portion 121 and the positioning groove 10B are spaced apart from the main body 10 along the X-axis direction, and can be provided at the same side of the lens hole 10A, or on two sides of the lens hole 10A. The sliding portion 121 is configured to be limited into the assembly cavity 30B of the sliding assembly 300. The positioning groove 10B is configured to cooperate with the positioning assembly 40 of the assembly mechanism 300 to limit the position in the O-XY plane.

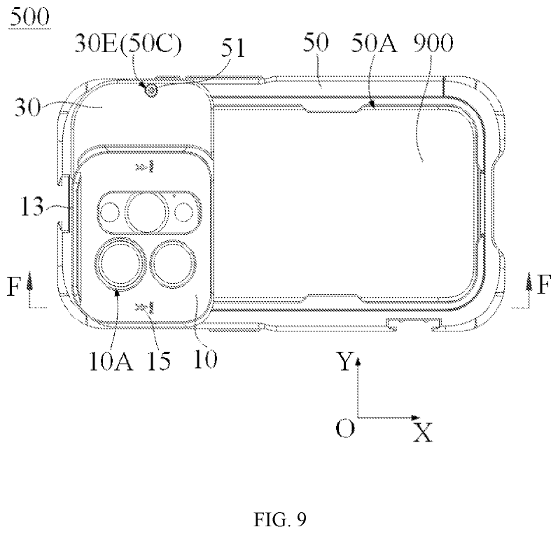

The fixed structure 12 may be one or multiple. In an embodiment, the switching mechanism 100 includes two fixed structures 12, as shown in FIG. 2, FIG. 9 and FIG. 13. Each of the fixed structures 12 is provided with the sliding portion 121 and the positioning groove 10B, two fixed structures 12 are distributed on two sides of the lens hole 10A, so that the two sliding portions 121 are provided on opposite sides of the lens hole 10A, and the two positioning grooves 10B are also provided on opposite sides of the lens hole 10A. The connection line of two sliding portions 121 is parallel to the Y-axis direction, or the connection line of one sliding portion 121 and one positioning groove 10B is parallel to the Y-axis direction. so that the opposite sides of the lens hole 10A on the switching mechanism 100 can be detachably assembled with the assembly cavity 30B respectively, thereby improving the assembly balance and stability.

It can be understood that the switching mechanism 100 is provided with at least one sliding portion 121 adjacent to the positioning groove 10B, a number of the assembly cavities 30B is corresponding to a number of the sliding portions 121, and at least one sliding portion 121 is spaced apart from the positioning groove 10B and is provided on the same side of the lens hole 10A. In an embodiment, each of the fixed structures 12 includes two sliding portions 121 spaced apart on two sides of the positioning groove 10B.

In an embodiment, one or more fixed structures 12 can be provided on the switching mechanism 100. Each of the fixed structures 12 may include at least two sliding portions 121. The assembly mechanism 300 is provided with the assembly cavity 30B corresponding to the sliding portion 121, the two sliding portions 121 are along the X-axis, and the two sliding portions 121 are spaced apart on two sides of the positioning groove 10B, so that the same side of the lens hole 10A is detachably assembled with the assembly cavity 30B through the two sliding portions 121. The main body 10 of the switching mechanism 100 on two sides of the positioning groove 10B is snapped and limited by the sliding portion 121 and the assembly hole in the Z-axis and Y-axis directions, and the main body 10 of the switching mechanism 100 between the two sliding portions 121 is elastically snapped by the positioning assembly 40 and the positioning groove 10B, so as to limit the position in the O-XY plane. The assembly method is simple, which can not only prevent the switching mechanism 100 from being skewed, but also reduce the adjustment steps of calibration and alignment, and improve the assembly balance and reliability.

In an embodiment, one or more fixed structures 12 can be provided on the switching mechanism 100. In an embodiment, two fixed structures 12 are provided on two sides of the lens hole 10A along the Y axis, so that the two sides of the main body 10 of the switching mechanism 100 can be detachably assembled to the assembly mechanism 300.

The switching mechanism 100 can be provided at the same side of the lens hole 10A, and can be provided with the sliding portion 121 and the positioning groove 10B, or can be provided with a combination of the sliding portion 121 and two positioning grooves 10B. When two positioning grooves 10B are provided, the two positioning grooves 10B are provided on two sides of the sliding portion 121 along the X-axis, and the switching mechanism 100 locates the main body 10 along the sliding direction at two points through the two positioning grooves 10B, which can prevent the assembly of the switching mechanism 100 from being tilted, so that the filter is positioned accurate and static relative to the lens module, and the picture quality of the filter is improved.

As shown in FIG. 1A to FIG. 7 and FIG. 9 to FIG. 10, in an embodiment, a blocking plate 13 is provided on one side of the main body 10. When the switching mechanism 100 slides along the assembly cavity 30B to the preset position or the limiting position, the blocking plate 13 is abutted against the outer edge of the assembly mechanism 300.

In an embodiment, the assembly mechanism 300 is provided with an avoiding gap 30D at one end of the assembly mechanism 300 along the X-axis direction. The switching mechanism 100 is provided with the blocking plate 13 corresponding to the avoiding gap 30D, and the blocking plate 13 is protruding from the main body 10 of the switching mechanism 100. As shown in FIG. 7, a length direction of the blocking plate 13 extends along the Y-axis direction, and a height direction of the blocking plate 13 extends along the Z-axis direction, and the blocking plate 13 protrudes toward the side of the main body 10 facing the assembly mechanism 300. The blocking plate 13 is provided on one edge of the main body 10, and specifically on the side of the main body 10 where the sliding portion 121 away from the assembly sliding direction. The blocking plate 13 is spaced apart from the sliding portion 121. When the assembly is completed, the blocking plate 13 is snapped at the avoiding gap 30D, the assembly sliding of the switching mechanism 100 along the X-axis direction is limited, thereby improving the alignment accuracy of the lens hole 10A after the switching plate is assembled.

As shown in FIG. 1A, FIG. 4, FIG. 12 and FIG. 13, in an embodiment, the switching mechanism 100 is circular; or, the switching mechanism 100 is rectangular.

In an embodiment, the shape of the switching mechanism 100 can be circular, rectangular, or other polygonal or irregular shapes. One end of the switching mechanism 100 facing the assembly mechanism 300 is provided with the sliding portion 121 or a combined structure of the sliding portion 121 and the positioning groove 10B, so as to detachably assemble with the assembly mechanism 300.

In an embodiment, a fool-proof structure 15 is provided on the side of the main body 10 away from the fixed structure 12, and the fool-proof structure 15 is configured for fool-proof assembly.

In an embodiment, the fool-proof structure 15 may be a printed fool-proof logo, or may be a ridge protruding from a side surface of the switching mechanism 100 away from the assembly mechanism 300. The fool-proof structure 15 can be a symbol, such as an arrow, or a text instruction, or can be a combination of the text and the symbol to intuitively determine the assembly position of the switching mechanism 100 and assembly mechanism 300, which improves the assembly efficiency, and reduces assembly errors.

It can be understood that, in addition to being assembled along the X direction as described above, the switching mechanism 100 and the assembly mechanism 300 can also be slidably assembled along the Y-axis direction, that is, the assembly cavity 30B can be assembled along the Y-axis direction, and the corresponding structure and orientation can be adjusted accordingly, which will not described here. The X-axis, Y-axis and Z-axis only assist in identifying the orientation and do not exclusively limit the structural setting orientation and assembly orientation of the rabbit cage apparatus 500.

In the assembly mechanism 300 for installing the switching mechanism 100 provided in the present application, the assembly mechanism 300 includes the installation member 30 and the positioning assembly 40, and the installation member 30 is provided with the assembly cavity 30B having the opening 30A. The positioning assembly 40 is provided at the installation member 30, and is spaced apart from the assembly cavity 30B. The assembly cavity 30B and the positioning assembly 40 are respectively configured to install and position the switching mechanism 100.

In an embodiment, as shown in FIG. 8, the assembly cavity 30B includes a pre-positioning cavity 301B and a clamping cavity 302B communicated with the pre-positioning cavity 301B. The installing member 30 is provided with an extending section 31 provided at a top of the clamping cavity 302B, and the opening 30A is provided at a top of the pre-positioning cavity 301B and communicated with the pre-positioning cavity 301B.

The pre-positioning cavity 301B is configured to pre-install the sliding portion 121 of the switching mechanism 100, and the clamping cavity 302B and the extending section 31 are configured to cooperate to limit and lock the jointing portion on the sliding portion 121 of the switching mechanism 100.

In an embodiment, on the assembly mechanism 300, the assembly cavity 30B includes the pre-positioning cavity 301B and the clamping cavity 302B communicated with the pre-positioning cavity 301B along the first direction. The assembly mechanism 300 is provided with the extending section 31 adjacent to the opening 30A, the extending section 31 is provided at the top of the clamping cavity 302B, and the opening 30A is provided at the top of the pre-positioning cavity 301B and is communicated with the pre-positioning cavity 301B. As shown in FIG. 8, the extending section 31 is designed as the sidewall of the assembly cavity 30B. When used, one end of the sliding portion 121 of the switching mechanism 100 inserts into the clamping cavity 302B along the Z direction, and slides to the limiting position or the preset position along the X direction. That is, the sliding portion 121 drives the bayonet 121A to slide until the bayonet 121A encounters and enters the extending section 31, and is assembled on the extending section 31 through the friction between the opening 1 and the extending section 31. At this time, the limiting segment 1212 is accommodated in the clamping cavity 302, as shown in FIG. 11.

In an embodiment, referring to FIG. 8, the opening 30A is provided at the top of the pre-positioning cavity 301B along the Z-axis direction, and the opening 30A is communicated with the pre-positioning cavity 301B. During assembly, the sliding portion 121 moves to insert into the pre-positioning cavity 301B through the opening 30A along the Z-direction. The assembly mechanism 300 is provided with the extending section 31 adjacent to the opening 30A, so that the clamping cavity 302B is provided at a bottom of the extending section 31 along the Z-axis direction, and the clamping cavity 302B is provided on one side of the pre-positioning cavity 301B along the X-axis direction. In addition, the thickness of the extending section 31 is matched with an opening width of the bayonet 121A or an opening width of the breach 121B, so that the bayonet 121A can be fixed by friction after being snapped into the extending section 31. The assembly cavity 30B is communicated with the opening 30A, the pre-positioning cavity 301B and the clamping cavity 302B, which roughly presents an L-shaped sliding cavity, and the opening 30A and the pre-positioning cavity 301B are communicated with to form a vertical edge of the L-shaped sliding cavity, and the pre-positioning cavity 301B is communicated with the clamping cavity 302B to form a transverse edge of the L-shaped sliding cavity.

The sliding portion 121 inserts into the pre-positioning cavity 301B along the Z-axis direction through the opening 30A to pre-position the assembly position of the assembly mechanism 300 and the switching mechanism 100. After that, the switching mechanism 100 slides along the X-axis direction so that one end of the sliding portion 121 inserting into the assembly cavity 30B slides to be snapped in the clamping cavity 302B, and the end of the sliding portion 121 is limited by the extending section 31 in the Z-axis direction and limited by the two sidewalls of the clamping cavity 302B in the Y-axis direction, which improves the assembly stability of the sliding portion 121 snapped in the assembly cavity 30B.

Further, along the extending direction of the X-axis, the assembly mechanism 300 is provided the accommodating groove 30 C spaced from the clamping cavity 302B, the switching mechanism 100 is provided with the positioning groove 10B spaced from the sliding portion 121, the positioning groove 10B is recessed, corresponding to the positioning assembly 40, at one side of the switching mechanism 100 facing the assembly mechanism, and the positioning assembly 40 is provided in the accommodating groove 30C.

When the switching mechanism 100 slides relative to the assembly mechanism 300 to the position where the positioning groove 10B directly faces the accommodating groove 30C, one end of the positioning assembly 40 pops out and is inserted into the positioning groove 10B to limit the sliding direction of the switching mechanism 100 and assembly mechanism 300 along the X-axis. The sliding portion 121 and the positioning assembly 40 can comprehensively limit the switching mechanism 100 and the assembly mechanism 300 along the X-axis, Y-axis and Z-axis directions, thereby improving the assembly reliability of the switching mechanism 100 and the assembly mechanism 300.

As shown in FIG. 2, FIG. 8, FIG. 10 and FIG. 11, in an embodiment, the sliding portion 121 of the switching mechanism 100 includes the connecting segment 1211 and the limiting segment 1212. One end of the connecting segment 1211 is connected to the main body 10, and the other end of the connecting segment 1211 can insert into the assembly cavity 30B through the opening 30A when assembly. The limiting segment 1212 is provided at the other end of the connecting segment 1211. The extending direction of the limiting segment 1212 is parallel to the sliding direction and is arranged at an angle with the connecting segment 1211. The connecting segment 1211, the limiting segment 1212 and the main body 10 are enclosed to form the bayonet 121A.

In an embodiment, the main body 10 of the switching mechanism 100 is plate-shaped, and the lens hole 10A is opened on the main body 10. The sliding portion 121 are distributed on two sides of the lens holes 10A and opposite to each other, and are configured to assemble the switching mechanism 100 and the assembly mechanism 300 through the assembly cavity 30B and the positioning assembly 40, so that the filter covers the original camera and realizes the replacement of different filters.

Referring to FIG. 6, a back of the main body 10 is attached to the assembly mechanism 300 along the O-XY plane and slides relative to the assembly mechanism 300 along the X-axis for assembly. As shown in FIG. 7, the sliding portion 121 includes the connecting segment 1211 and the limiting segment 1212. The connecting segment 1211 is provided on the back of the main body 10 and extends along the Z-axis direction. One end of the connecting segment 1211 is connected to the main body 10, and the other end of the connecting segment 1211 extends into the assembly cavity 30B through the opening 30A along the Z axis when assembly. The limiting segment 1212 is provided at the other end of the connecting segment 1211 away from the back of the main body 10, and extends along the X-axis direction and is arranged perpendicularly to the connecting segment 1211 to slide and insert into the assembly cavity 30B and plays the limiting role.

As shown in FIG. 6 to FIG. 8, in the pre-assembly stage, the connecting segment 1211 and the limiting segment 1212 insert into the pre-positioning cavity 301B of the assembly cavity 30B along the Z-axis direction through the opening 30A, and a relative position of the switching mechanism 100 and the assembly mechanism 300 is pre-positioned. After the pre-positioning, the switching mechanism 100 is pushed along the X-axis direction relative to the assembly mechanism 300 to push the limiting segment 1212 move and insert into the clamping cavity 302B, that is, the extending section is inserted into the bayonet 121A formed by the connecting segment 1211, the limiting segment 1212 and the main body 10 to complete the assembly.

As shown in FIG. 9 to FIG. 11, when the assembly is completed, the entire sliding portion 121 is limited and locked inside the assembly cavity 30B, and the positioning assembly 40 is snapped and limited in the positioning groove 10B. The limiting segment 1212 is circumferentially limited along the Y-axis and the Z-axis by the clamping cavity 302B and the extending section 31, and the positioning assembly 40 cooperates with the positioning groove 10B to limit the relative displacement of the switching mechanism 100 and the assembly mechanism 300 along the X-axis, which improves the assembly reliability of the assembly mechanism 300 and the switching mechanism 100.

Further, as shown in FIG. 3, FIG. 5A, FIG. 7 and FIG. 10, the installation member 30 of the assembly mechanism 300 has a thickness along the Z-axis direction, so that a side surface of the installation member 30 fitted with the switching mechanism 100 is recessed with the assembly cavity 30B, the accommodating groove 30C and the window 337. The switching mechanism 100 is slidably and detachably assembled to the installing member 30, so that the assembly mechanism 300 can be detachably assembled with the switching mechanism 100.

Referring to FIG. 7, FIG. 8, FIG. 10 and FIG. 11, in an embodiment, the positioning assembly 40 includes an elastic member 41 and a positioning member 42. The elastic member 41 is provided in the accommodating groove 30C, one end of the elastic member 42 is connected to the accommodating groove 30C, and the other end of the elastic member 42 is provided with the positioning member 42. The positioning member 42 is driven by the elastic member 41 to be elastically snapped in the positioning groove 10B.

In an embodiment, a compressing or a stretching direction of the elastic member 41 is provided at an angle with the sliding direction of the switching mechanism 100 relative to the assembly mechanism 300.

As shown in FIG. 8, in an embodiment, the switching mechanism 100 slides relative to the assembly mechanism 300 along the X-axis direction for assembly or disassembly. The compressing or the stretching direction of the elastic member 41 is parallel to the Z-axis direction, and the two directions are arranged at an angle. The angle may be a right angle, or an acute or an obtuse angle close to the right angle. The accommodating groove 30C is opened on the side of the installing member 30 of the assembly mechanism 300 facing the switching mechanism 100, that is, the notch of the accommodating groove 30C is opened towards the Z-axis. One end of the elastic member 41 along the Z-axis direction is connected to the bottom wall of the accommodating groove 30C, and the positioning member 42 is relatively fixed at the other end of the elastic member 41 along the Z-axis direction, so that the positioning member 42 is snapped in the positioning groove 10B through the elastic energy storage and release of the elastic member 41 after the jointing portion locks the assembly sidewall 2 of the assembly mechanism 300.

The elastic member 41 can be a spring, the positioning member 42 can be a positioning column or a spherical positioning bead with an arc top surface, and the positioning groove 10B can be an arc-shaped inner concave surface. The inner concave surface of the positioning groove 10B is adapted to a contact surface of the positioning column or the positioning bead, which improves the tightness of the snapped positioning of the switching mechanism 100 and the assembly mechanism 300. The positioning member 42 can be a bead, and the opening of the accommodating groove 30C is smaller than a diameter of the bead. Therefore, the bead can be pushed by the elastic member 41 to partially protrudes from the notch of the accommodating groove 30C without completely falling out of the accommodating groove 30C.

In an embodiment, the cage frame 50 is provided with an installation position, and the assembly mechanism 300 is detachably connected to the installation position.

Specifically, a periphery of the cage frame 50 adjacent to the installation position is provided with an installation hole 50C, and the assembly mechanism 300 is provided with a fixing hole 30E. The rabbit cage apparatus 500 also includes a fastener 51 passing through the fixing hole 30E to be threadedly connected to the installation hole 50C.

In an embodiment, the installation position of the cage frame 50 corresponds to the position of the camera module of the terminal device. Two opposite peripheries of the cage frame 50 adjacent to the installation position are provided with at least one installation hole 50C. Two sides of the installing member 30 of the assembly mechanism 300 are provided with fixing holes 30E corresponding to the installation hole 50C. One end of the fixing hole 30E away from the cage frame 50 is recessed with a protecting groove for avoiding the end of the fastener 51. The fixing hole 30E can be a via hole, the installation hole 50C can be a threaded hole, and the fastener 51 can be a screw or a bolt. The protective groove is configured to protect the nut of the screw or the bolt from denting, so as to prevent the nut from protruding from the surface of the installing member 30. It can not only prevent scratches, but also prevent screws or bolts from loosening due to long-term accidental contact, thereby improving the reliability of the detachable connection between the installing member 30 and the cage frame 50.

In an embodiment, as shown in FIG. 2, FIG. 5A and FIG. 13, the rabbit cage apparatus 500 also includes a soft layer 60, and the soft layer 60 is provided on the assembly mechanism 300 or on the switching mechanism 100. When the assembly mechanism 300 is assembled with the switching mechanism 100, the soft layer 60 is provided between the switching mechanism 100 and the assembly mechanism 300.

In an embodiment, the soft layer 60 is provided on the assembly mechanism 300 or the soft layer 60 is provided on the switching mechanism 100. The soft layer 60 is a rubber layer, a silicone layer, a foam layer, or other flexible cushions. After assembly, the soft layer 60 is provided between the switching mechanism 100 and the assembly mechanism 300 to compensate for the gap difference between the main body 10 and the installing member 30, which improves the assembly compactness of the switching mechanism 100 and the assembly mechanism 300, increases the friction force of the switching mechanism 100 and the assembly mechanism 300 in the O-XY plane, prevents the switching mechanism 100 from retracting in the sliding direction, and ensures the reliable assembly.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A switching mechanism, configured to mount on an assembly mechanism, comprising:
a main body provided with a lens hole for installing a filter; and
at least one fixed structure provided on the main body, wherein the fixed structure comprises a sliding portion provided with a jointing portion,
wherein the sliding portion is configured to slidably mount on the assembly mechanism, and the jointing portion is configured to lock the assembly mechanism.

2. The switching mechanism of claim 1, wherein the jointing portion is provided with a bayonet configured to snap with the assembly mechanism.

3. The switching mechanism of claim 2, wherein the sliding portion comprises:
a connecting segment, wherein one end of the connecting segment is connected to the main body; and
a limiting segment provided at the other end of the connecting segment, wherein the connecting segment, the limiting segment and main body are enclosed to form the bayonet.

4. The switching mechanism of claim 2, wherein the bayonet is a breach recessed on the sliding portion.

5. The switching mechanism of claim 1, wherein the fixed structure is provided with at least one positioning groove configured to position the main body to the assembly mechanism.

6. The switching mechanism of claim 1, wherein the switching mechanism comprises two fixed structures spaced apart on opposite sides of the lens hole.

7. The switching mechanism of claim 1, wherein the switching mechanism is circular; or the switching mechanism is rectangular.

8. An assembly mechanism, configured to install a switching mechanism, comprising:
an installing member;
wherein the installing member is provided with an assembly cavity having an opening, and the assembly cavity is configured for mounting the switching mechanism; and
an extending section is provided on an edge of the assembly cavity, and the extending section is configured to lock the jointing portion of the switching mechanism.

9. The assembly mechanism of claim 8, wherein the assembly cavity comprises a pre-positioning cavity and a clamping cavity communicated with the pre-positioning cavity; and
the extending section is provided at a top of the clamping cavity, and the opening is provided at a top of the pre-positioning cavity and is communicated with the pre-positioning cavity.

10. The assembly mechanism of claim 8, further comprising:
at least one positioning assembly provided in the installing member;
wherein the positioning assembly is configured to position the switching mechanism.

11. The assembly mechanism of claim 10, wherein the installing member is provided with at least one accommodating groove corresponding to the positioning assembly so that the positioning assembly is installed in the accommodation groove; and
one end of the positioning assembly is elastically installed in the accommodating groove, and the other end of the positioning assembly is configured to elastically limit the switching mechanism.

12. The assembly mechanism of claim 11, wherein the positioning assembly comprises:
an elastic member provided in the accommodating groove, wherein one end of the elastic member is connected to a bottom wall of the accommodating groove; and
a positioning member provided at the other end of the elastic member, wherein the elastic member is configured to drive the positioning member to elastically abut against the switching mechanism.

13. The assembly mechanism of claim 12, wherein a compressing or a stretching direction of the elastic member is perpendicular to a plane where the installing member is located.

14. A rabbit cage apparatus, comprising:
a cage frame;
an assembly mechanism configured to install a switching mechanism, comprising:
an installing member;
wherein the installing member is provided with an assembly cavity having an opening, and the assembly cavity is configured for mounting the switching mechanism;
an extending section is provided on an edge of the assembly cavity, and the extending section is configured to lock the jointing portion of the switching mechanism, and
the assembly mechanism is provided on the cage frame; and
the switching mechanism of claim 1, wherein the switching mechanism is detachably mounted on the assembly mechanism through the fixed structure.

15. The rabbit cage apparatus of claim 14, further comprising:
at least one soft layer;
wherein the at least one soft layer is provided on the assembly mechanism and/or the switching mechanism; and
in response to that the assembly mechanism is assembled with the switching mechanism, the soft layer is provided between the switching mechanism and the cage frame.
